(19) United States
(12) Patent Application Publication
(10) Pub. No.: US 2020/0112633 A1
(43) Pub. Date: Apr. 9, 2020

(54) METHOD FOR USING INTERCOM TO PERFORM INTELLIGENT CALLING PROCESS, INTELLIGENT CALLING APPARATUS AND SYSTEM THEREOF

(71) Applicant: Keenstar Corporation, Taipei City (TW)

(72) Inventors: LI-WEN LIAO, Taipei City (TW); WAN-CHEN CHEN, Taipei City (TW); YEN-TING HO, Taipei City (TW)

(21) Appl. No.: 16/151,615

(22) Filed: Oct. 4, 2018

(51) Int. Cl. H04M 3/42; H04W 4/02; H04M 11/02; H04L 29/06

(52) U.S. Cl. CPC H04M 3/42042; H04L 65/1076; H04M 11/02; H04W 4/02

(57) ABSTRACT

A method for using an intercom to implement an intelligent calling process, an intelligent calling apparatus and a system is presented. The method is adapted to a site that adopts intercoms to perform a calling process. The system utilizes a server for receiving a calling signal generated by an intelligent calling apparatus. The calling signal records ID information used to represent a calling location. The server obtains the calling location by querying a database. The software process running in the server combines voice signals according to the calling location. A calling voice is generated and sent to the intercoms carried by the personnel member. When any personnel members receive the calling voice by the intercom, this calling process can be completed as the personnel member arrives at the calling location.

### FIELD OF THE DISCLOSURE

The present disclosure relates to a method for intelligent calling process, and more particularly to a method for using intercom to perform intelligent calling process and a method for intelligent calling process to perform notification and calling management through a server, an intelligent calling apparatus and system thereof.

### BACKGROUND OF THE DISCLOSURE

Advancement in communication technology drives the development of the Internet of Things (IoT). These developments of the IoT are reflected in applications. Normally, there are many sensors placed in a location, and users can obtain some events in the location through the sensors. For example, information such as temperature, power, and light detected by the sensors, and subsequent processing process are about the corresponding responses based on various sensed events.

A device with IoT features can often provide an automatic process. For example, applications are located in a place where services needed, such as a bank, a restaurant, a store, etc., and a motion sensor can be installed at the door to sense people entrancing through the door. The system will automatically send messages, such as ring tones, voices, etc., so that personnel member can timely provide services.

However, many applications in the IoT lack any interactions with people (customers). When users acquire some specific events through the sensors, those events do not combine with the related service processes for the customers during the event process.

### SUMMARY OF THE DISCLOSURE

In response to the above-referenced technical inadequacies, the present disclosure provides a method for using intercom to perform intelligent calling process, an intelligent calling apparatus and system thereof to integrate software and hardware and provide an automatic process for places requesting service or emergency calling. The method and system in the disclosure combine service calling and personnel member calling to complete the service.

The disclosure is a method for using intercom to perform intelligent calling process, intelligent calling apparatus and system thereof. The disclosure integrates software and hardware and provides automatic prosecution process according to those places requested service or emergency calling. Accordingly, the disclosure combines calling request and personnel member calling to complete the service.

According to embodiment in the system for using intercom to perform intelligent calling process, hardware equipment integrated in the system includes a plurality of intercoms carried by a plurality of personnel member, a plurality of intelligent calling apparatuses disposed at a plurality of calling locations and a server. The intercoms are communication devices carried by the personnel member. The intelligent calling apparatuses are disposed at the locations where requesting to generate calling, e.g., the locations where customers can control, the locations where the sensors are installed and etc. The server is configured to perform an intelligent calling method. The server can be executed within a server host and embedded within one of terminal devices. Moreover, in a specific embodiment, the system can install a gateway at somewhere within the place and the gateway is used to transfer information generated by the intelligent calling apparatus.

At first, the server receives a calling signal generated by one of the intelligent calling apparatus and the calling signal records identification (ID) information of the intelligent calling apparatus. The ID information in a service place is corresponding to a calling location. Then, the server queries a personnel database according to the ID information to acquire calling information of at least one personnel member corresponding to the ID information. At this moment, a software program in the server combines voice signals to form a calling voice and the calling voice is transmitted through the intercoms carried by the relevant personnel member. When one of the personnel members receives the calling, the personnel member will move to the calling location to perform service.

In the method for using the intercom to perform the intelligent calling process, when the personnel member moves to perform the service, the process for the method is completed. In another embodiment, when the personnel member arrives at the calling location, a calling disable signal is generated by the intelligent calling apparatus and transmitted to the server to complete the entire process.

According to one embodiment, a main circuit in the intelligent calling apparatus includes a control unit, a trigger unit generating a calling signal to customers and a communication unit connected to the server to transmit the calling signal to the server.

In the embodiment of the method for intelligent calling process, the server will receive the calling signal generated by one of the intelligent calling apparatuses and the ID information within the calling signal is corresponding to the calling location. The server queries a personnel database according to the ID information to acquire the calling information corresponding to the at least one personnel member. Thereafter, the server transmits the calling signal to the intercoms carried by the personnel member.

When one of the personnel members arrived at the location of the intelligent calling apparatus, which generates the calling signal, the entire service calling process is completed.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 is a schematic view illustrating a system for using intercom to perform intelligent calling apparatus.

FIG. 2 is another schematic view illustrating the system for using the intercom to perform the intelligent calling apparatus.

FIG. 3 is a schematic view of circuit components of each device in the system for using the intercom to perform the intelligent calling apparatus.

FIG. 4 is a system flow diagram illustrating the method for using the intercom to perform the intelligent calling method in the embodiment.

FIG. 5 is a flow chart of the method for using the intercom to perform the intelligent calling process in the server of the system.

FIG. 6 is a flow char illustrating the steps that the intelligent calling apparatus disables the calling process in the embodiment.

FIG. 7 is a flow char illustrating the steps after the server receives the disable signal.

FIG. 8 is a flow char illustrating the method for using the intercom to perform the intelligent calling process in the embodiment.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is a method for using intercom to perform intelligent calling process, an intelligent calling apparatus and method thereof, and can be implemented in many places, such as banks, shopping malls, restaurants, day care facilities, airplanes, cruises, factories, warehouses, schools, etc., where need to provide personnel member calling or securities service. The intelligent calling apparatus can be an electronic device installed in a specific location and generates a calling signal by triggering a button or a specific interface of an electronic device through a person nearby. The intelligent calling apparatus can be a sensor, such as a temperature sensor, a motion sensor, an image sensor, etc., disposed at the specific location. When the sensor is triggered by a specific event, a calling signal is transmitted to the server.

For example, the system is installed in a place for providing personnel service. When the customers enter the place and the personnel member needs to provide service in front of the customers, one of the intelligent calling apparatuses, such as a service bell with communication function, a touch apparatus, a computer, and etc., close to the customers is triggered. The server in the place will notify the personnel member responsible or close to the specific place to move to the place according to the location of the intelligent calling apparatus, which generates the service calling.

If the system is installed in the place requesting security control, the sensor is used as the intelligent calling apparatus. When sensing an abnormal situation, for example the server determines some situations through the sensor, such as intruders, abnormal temperature and humidity, and etc., the sensor will generate the calling signal. The server receives the calling signal and determines the calling location so as to notify the relevant personnel member by voice to move to the calling location and handle the situation.

It should be noted that, according to one embodiment, the method for using the intercom to perform the intelligent calling process disclosed herein is to implement the intercom carried by the personnel member. The intercom is normally configured to receive and transmit voices, and a voice conversation can be made through the specific communication channel appointed by each other. The server in the system combines voice signals according to the calling content to form a calling voice. A Voice-Operated Switch (VOX) technique is used to convert the calling voice to be the voice message transmitted via a specific communication channel, and then the voice message is transmitted or broadcast through a preassigned channel to the intercom carried by the personnel member. The voice signals at the server end are the pre-recorded or pre-produced voice signals and saved in the database. The software program acquires the relevant voice signals according to the calling information and the calling location to combine the voice signals so as to form the calling voice heard by the personnel member through the intercoms.

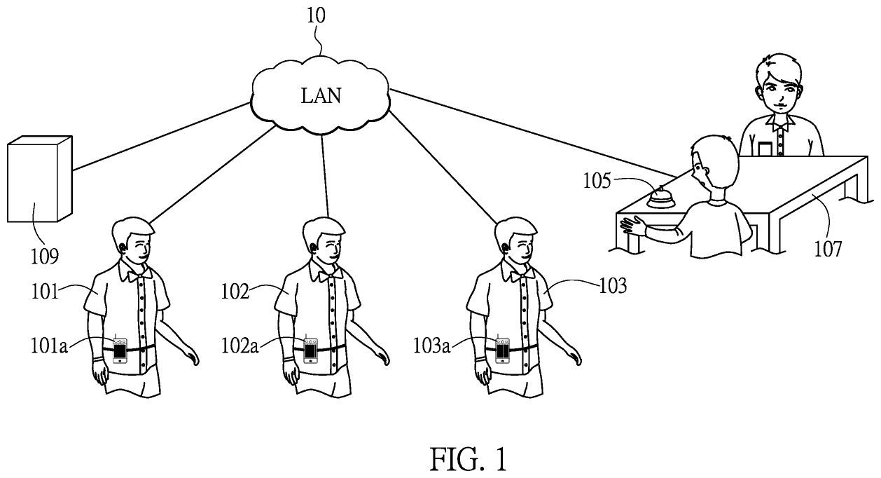

The system for using the intercom to perform the intelligent calling process disclosed herein includes a server, an intelligent calling apparatus and an intercom carried by personnel member. The server can be a standalone server host as shown at the embodiment in FIG. 1, a software program installed within a terminal device with data process capability, a software program installed within a Point of Sale (POS) running in a commercial area or a software program embedded within the security host. The server is connected to the intelligent calling apparatus via a local area network (LAN), such as Internet, WiFi™ or any other networks related to Near Field Communication (NFC). The intercom carried by the personnel member is a conventional voice communication device or may be the computer device capable of performing voice communication, but it is not limited herein. The intelligent calling apparatus may refer to a regular service bell, a calling device, a sensor, and etc., and is not limited to a specific device.

The system for using the intercom to perform the intelligent calling process is to provide a responsible managing measure when requesting personnel member service or requesting to call some personnel member in a place to handle some situations. By managing through the server, special personnel member can be arranged for different events, different places or different locations. The system in the present disclosure can also arrange a substitute, and a calling sequence for many personnel member is also arranged in the overlapped duty area. When one of the personnel members responsible in the specific area actively or inactively indicates that he or she is unable to provide service, the system will automatically call the substitute to provide service at the calling location according to a priority for the substitutes.

The embodiment of the present disclosure is referring to a schematic view illustrating the system for using the intercom to perform the intelligent calling process in FIG. 1. The system for using the intercom to perform the intelligent calling process is a software and hardware integration solution. The hardware equipment includes a server host 109, an intelligent calling apparatus 105 and a plurality of intercoms 101a, 102a, 103a carried by a plurality of personnel members 101, 102, 103.

A calling location 107 is shown in FIG. 1, and the embodiment is taking each table, a counter to call the personnel member or a specific location as the example. Some of the customers are close to the calling location 107, and the intelligent calling apparatus 105 nearby can be a service bell, a food order device or a computer device with a display function.

The server is run in a server host 109 and the server host 109 performs signal transmission by connecting to the intelligent calling apparatus 105 via the LAN 10. The process unit in the server host 109 executes the software program within the memory and performs the method for using the intercom to perform the intelligent calling process.

In the embodiment, the customer in the calling location 107 generates and outputs a calling signal through the intelligent calling apparatus 105. The calling signal records identification (ID) information of the intelligent calling apparatus 105, and the ID information in the database of the server host 109 is corresponding to the calling location 107. The software program executed in the server host 109 receives the calling signal via the LAN 10 and queries a personnel database according to the ID information to query one or more personnel members corresponding to the calling location. In the present embodiment, the calling information for one or more personnel members 101, 102, 103, which are corresponding to the ID information, is acquired according to a comparison result. In order to transmit message to a communication channel of the intercoms 101a, 102a, 103a carried by the personnel members 101, 102, 103, the embodiment pre-assigns a calling frequency corresponding to the channel. The personnel members can be arranged in different groups and each of the groups may set up one of different calling channels. In the specific embodiment, if one of the calling channels is consistently assigned in one area, the server host 109 will transmit the calling voice in a broadcast manner via the specific calling channel.

Thereafter, after one of the personnel members 101, 102, 103 received the calling, the personnel member will move to the calling location 107 to provide service. After the personnel member has arrived in the calling location 107, the service calling process is completed. In one embodiment, the intelligent calling apparatus can include a trigger interface to disable the calling. Therefore, when the personnel member has arrived in the calling location, the personnel member can manually disable the calling signal via the trigger interface (such as a button), and the calling process is completed.

However, according to another embodiment, if the intercoms 101a, 102a, 103a carried by the personnel members respectively include a specific signal transmitting circuit to acquire a distance between the intercoms 101a, 102a, 103a and the intelligent calling apparatus 105, which generates the calling signal, according to the signal strength. When the software program in the intelligent calling apparatus 105 determines the distance is greater than a threshold value, the intelligent calling apparatus 105 will generate a disable signal and transmit the disable signal to the server host 109 so as to complete the calling process.

For example, the intelligent calling apparatus 105 can be installed in a kitchen of a restaurant, and the ID information of the intelligent calling apparatus 105 is corresponding to the location of the kitchen. When the intelligent calling apparatus 105 generates the calling signal, for example, a chief chooses the calling location (such as table number) after finishing cooking and sets a time limit for the calling process. The server host 109 executes the calling process (e.g., timing is started), and the server host 109 determines the dish order is ready and acquires the calling location. The calling signal is released according to a personnel look-up table in the database for the restaurant personnel members to request one of the specific personnel members to deliver the dish to the corresponding calling location (table) from the kitchen.

Furthermore, a notifying and reminding function can be set by the software in the server host 109. In other words, when one of the customers arrives at one of the calling locations, the system will remind the corresponding personnel member to provide service within the time limit via the server host 109. The system can set up a time limit to remind a meal time, a closing time, a special promotion time, a holiday and etc., for the customers through the personnel members.

In the services run by the server host 109, aside from providing the calling signal to the specific personnel member or the specific group according to the personnel look-up table, the system can further transmit a message, e.g., some of the dishes sold out, some of the new dishes available now, new promotion released, time to close, equipment checking, inventory checking and etc., to all of the personnel member or some of the personnel member according to the specific event in the embodiment of the restaurant service.

In one embodiment, when the signal processing capability and the memory in each of the terminal devices (such as the intelligent calling apparatuses) include a certain performance, the server functions (e.g., the server function performed by the software program) performed by the server host 109 can be embedded within one of the terminal devices.

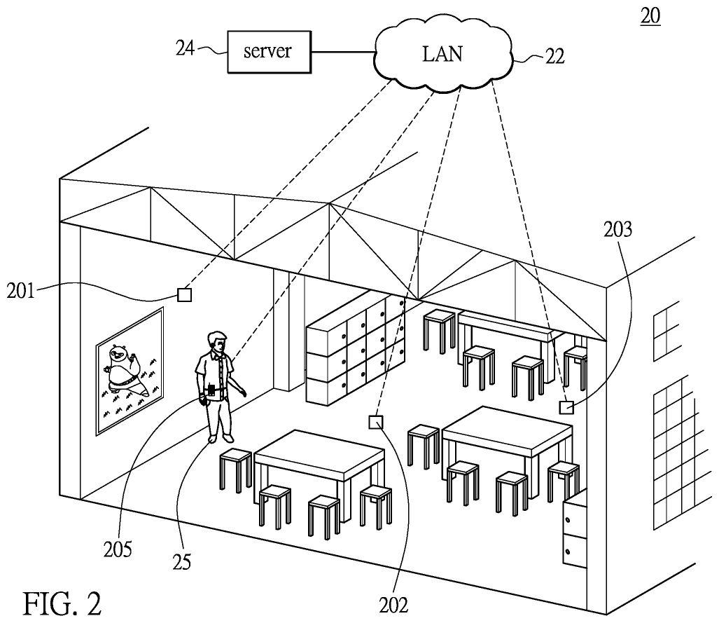

The system for using the intercom to perform the intelligent calling process can be applied in the area, such as warehouses or schools where requesting security control. Another embodiment shown in FIG. 2 illustrates that the sensors 201, 202, 203 are installed at many different locations in a warehouse and used as the intelligent calling apparatus in the system. The sensors 201, 202, 203 are configured to detect environmental events at the locations within the warehouse 20. When the software program detects the abnormal situation, the software program will automatically generate the calling signal and transmit the calling signal to the server 24 of the system via a LAN 22.

The server 24 can search the location for one of the sensors in accordance with the information, such as the ID information corresponding to one of the locations, within the calling signal to generate the calling voice. The calling voice is transmitted to the intercom 205 of the relevant personnel member 25 and the personnel member 25 is notified by the voice to move to the calling location within the warehouse 20. Then, after one of the personnel member 25 moves to the location indicated by the calling voice, in one embodiment, a disable signal is generated according to a disable calling function in the sensor 201 and transmitted to the server 24 via the LAN 22 so as to complete the intelligent calling process.

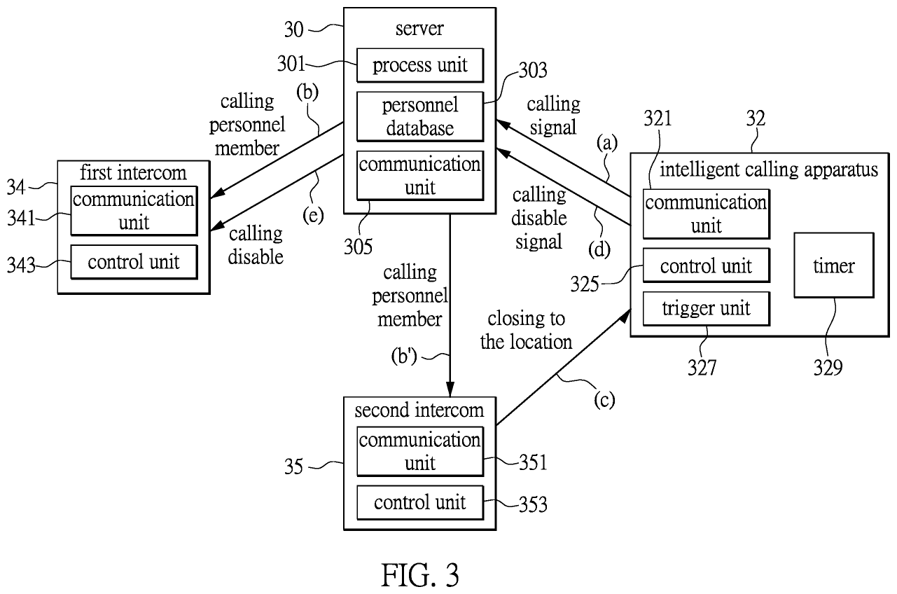

FIG. 3 is a schematic view illustrating circuit components of the system for using the intercom to perform the intelligent calling process. In the embodiment, the server host 30 is used as the server of the system. The server 30 includes a process unit 301, a personnel database 303 and a communication unit 305. The intelligent calling apparatus 32 mainly includes a communication unit 321, a control unit 325, a trigger unit 327 and a timer 329. In the embodiment, a first intercom 34 and a second intercom 35 are carried by the personnel members and include control units (343, 353) and communication units (341, 351) electrically connected to the control units (343, 353).

It should be noted that the intelligent calling apparatus 32 in the embodiment can include a proximity sensor close to the intercom. If the intercom includes a signal transmitting circuit, the intelligent call apparatus may determine the distance in accordance with signal strength (such as Received Signal Strength Indicator, RSSI), and the distance is used to be a reference to trigger the calling disable signal.

The control unit 325 of the intelligent calling apparatus 32 is similar to a microprocessor, and used to process a triggered service event, such as generating the calling signal. In one embodiment, the intelligent calling apparatus 32 includes the trigger unit 327, such as a service bell button, a touch button or any other manners (like voice to generate a calling signal) to trigger service calling. The trigger unit 327 is electrically connected to the control unit 325, and the calling signal is generated through the control unit 325 after triggering. The communication unit 321 is included in the intelligent calling apparatus 32 and electrically connected to the control unit 325 to perform a wireless or wired communication protocol. The communication unit 325 is configured to connect to the server 30 and transmit the calling signal to let the server 30 query the calling information, corresponding to the ID information of the calling signal, for one or more personnel members.

As the method for using the intercom to implement the intelligent calling process in the embodiment of the disclosure, when the personnel member arrives at the calling location, the personnel member or the customer may manually operate the intelligent calling apparatus or the intercom to generate the disable signal to disable the calling process.

The intelligent calling apparatus 32 includes a timer 329 electrically connected to the control unit 325. When the consumer implements the intelligent calling apparatus to generate the calling signal, the timer 329 is synchronously activated to start timing. After timing time exceeds a timing threshold value, one of the personnel members is still not showing in the calling location or the action to trigger the disable calling is not started, the calling signal is resent to remind the system to page the personnel member moving to the calling location.

According to the embodiment in the diagrams, when the method for using the intercom to implement the intelligent calling process is performed in the system, the process is started when the intelligent calling apparatus 32 transmits the calling signal (a) to the server 30. The server 30 receives the calling signal (a) through the communication unit 305 in a communication manner. The calling signal (a) includes ID information corresponding to the calling location of the device, which transmits the calling signal. After the process unit 301 executes the calling signal, the personnel database is queried in accordance with the ID information of the intelligent calling apparatus 32 to acquire the personnel member corresponding to the calling location.

At the same time, the process unit 301 in the server 30 executes the software program to search the corresponding personnel member according to the calling location and also query the calling information, such as the call frequency (channel) of the intercom, for the corresponding personnel member. Particularly, the calling voice is formed by the software program of the server 30 according to the calling location or further including the calling voice formed by some voice signals combined through the calling information. The calling voice is transmitted to each of the intercoms via the assigned channel by implementing the VOX technique. The circuits related to the VOX technique are installed in the communication circuit of the server 30 to perform voice conversion and transmission.

Thereafter, the calling voice is broadcast by the server 30 via a specific voice channel to the first intercom 34 and the second intercom 35 acquired by comparing in the database. In the embodiment, the first intercom 34 transmits the calling signal (b) to the first personnel member and the second intercom 35 transmits the calling signal (b′) to the second personnel member at the same time.

Then, in the embodiment, the personnel member having the second intercom 35 received the voice instruction of the calling location in the embodiment, and moves to the location (C) of the intelligent calling apparatus 32. After the personnel member has arrived at the location (C), the intelligent calling apparatus 32 generates and transmits the calling disable signal (d) to the server 30. At the same time, the software program in the server 30 also generates another calling disable signal to notify another personnel member, who are the personnel member carrying the first intercom 34 in the embodiment. Another the calling disable voice (e) is also generated by the software program in the server 30 to notify another personnel member, who is the personnel member carrying the first intercom. The calling disable voice (e) is transmitted to the first intercom 34 carried by the personnel member to show that the present calling process is completed and the personnel member does not need to go to the calling location.

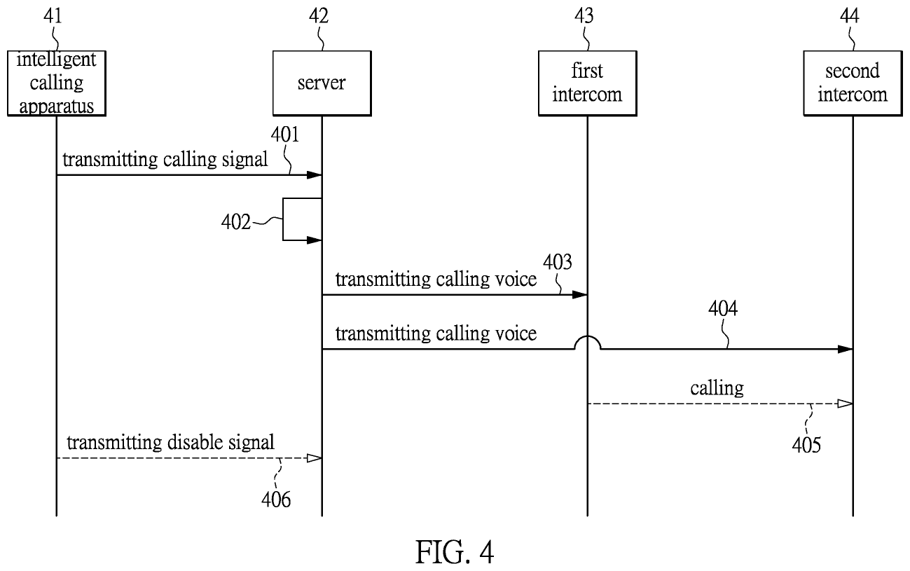

FIG. 4 is a system flow diagram illustrating the method for using the intercom to perform the intelligent calling method in the embodiment. The operation of the flow described in the embodiment is among the intelligent calling apparatus 41, the server 42, the first intercom 43 and the second intercom 44 carried by many personnel members.

By starting from the intelligent calling apparatus 41, when someone is in the location of the intelligent calling apparatus 41, the calling signal is generated through the triggering function (such as a button) of the apparatus. Alternatively, in the embodiment having the sensor, when the intelligent calling apparatus 41 detects the specific event, the calling signal is generated. The calling signal includes the ID information of the intelligent calling apparatus. The ID information is corresponding to the installation location (the calling location) of the intelligent calling apparatus. Thereafter, the calling signal is transmitted to the server.

In the server 42, the software program is run to combine multiple voice signals related to the ID information according to the ID information of the calling signal to form the calling voice (step 402). Thereafter, the server 42 transmits the calling voice. In the embodiment without differentiating between the personnel members, the server 42 will transmit the calling voice to the first intercom 43 (step 403) and the second intercom 44 (step 404). The server 42 may acquire the relevant personnel member or group (such as a name or a title) corresponding to the calling location firstly, and the information is converted to be the calling voice to let all of the personnel members carrying the intercoms to knowledge the transmitting target, who can receive the message. In another embodiment, if the intercoms carried by each personnel member have a specific communication channel respectively and will not be interrupted by each other, and the server 42 needs to determine the transmitting target, the aforementioned VOX technique is implemented to transmit the calling voice to the specific intercom via a specific channel.

In one embodiment, according to the function of the common intercom, when the personnel member carrying the first intercom 43 receives the calling voice but the personnel member is not available, the personnel member needs someone else to assistant or due to any other reasons, one of the channels still can be used to notify other personnel member (the second intercom 44) (step 405).

Thereafter, the process in the method may include a step to add the disable signal. In other words, when one of the personnel member arrived at the location of the intelligent calling apparatus 41, which transmits the calling signal, the disable signal is generated and transmitted to the server 42 to show the message that the personnel member have arrived to perform the service (step 406).

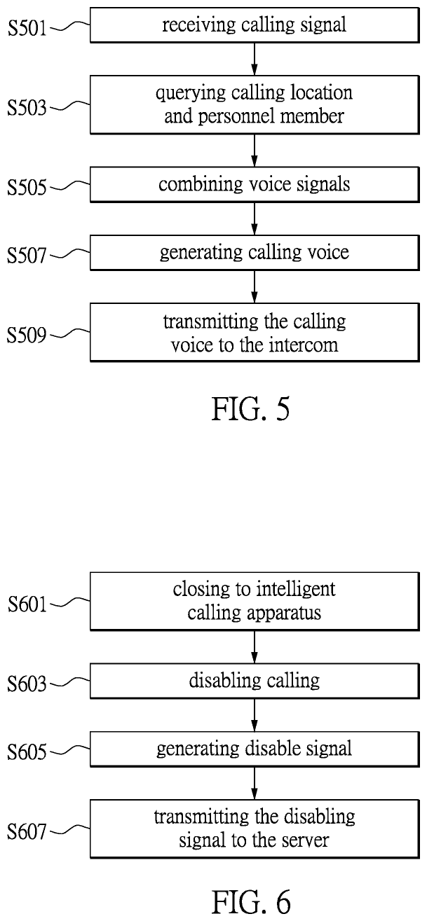

FIG. 5 is a flow chart of the method for using the intercom to perform the intelligent calling process in the server of the system.

In step S501, the server receives the calling signal generated by the intelligent calling apparatus in the certain location, and the calling signal includes the ID information to recognize the intelligent calling apparatus. In step S503, the database is queried in accordance with the ID information to acquire the corresponding calling location and the relevant personnel member. The personnel members can be arranged into many different groups according to the different calling locations. Each of the groups can include a specific communication channel without interrupting to other groups. The server may determine to transmit the calling voice to just one group or many groups. According to the querying result, the information can include the calling information for each of the personnel members, such as the name of the personnel member or further including the communication channel of the intercom. The information can be the content of the combination of the calling voice. In step S505, the software program in the server acquires the voice signals recorded or produced by the system according to the calling location corresponding to the ID information and the appellation (e.g., names, titles, nicknames and etc.) of the relevant personnel member or made by the computer voice, and then combines the signals together.

In step S507, the calling voice is formed in the server and the calling voice can include information related to the current calling process, such as a location, a duty and etc. Thereafter, the calling voice is transmitted via the specific channel to the intercoms for each personnel member, e.g., in step S509.

FIG. 6 is a flow char illustrating the steps that the intelligent calling apparatus disables the calling process in the embodiment.

When one of the personnel members is notified to move to the calling location, as in step S601, one of the personnel members is close to the intelligent calling apparatus and the trigger function of the intelligent calling apparatus is activated to represent that one of the personnel members is arrived at the scene. In step S603, the calling is requested to disable when the personnel member has arrived at the scene. In step S605, the calling disable signal is generated. In step S607, the disable signal is transmitted to the server. The aforementioned steps are used for the server in the system to record all of the events and realize the calling process is completed.

If the process includes a situation that one of the personnel members is not available in the scene and it is requested to have someone to substitute, a situation requests to retransmit the calling voice when no one shows in the scene after a period of time or a situation that the calling signal of the intelligent calling apparatus has passed a time limit without disabling so that the calling signal is requested to retransmit. The process can be the event recorded in the system and the event is accordingly become the information of the data processing. If the event is a service process, the event can be used to improve the service process. If the event is a security process, the event can be used as an evident whether the security is requested to improve or not.

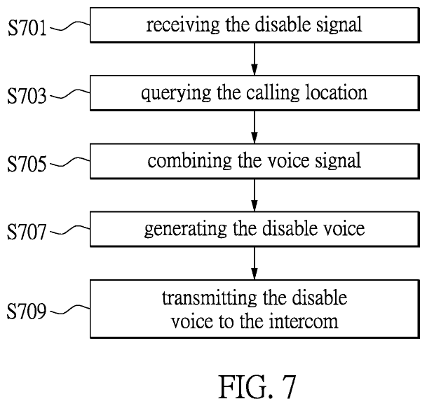

FIG. 7 is a flow char illustrating the steps after the server receives the disable signal.

During the process, in step S701, the server receives the disable signal from one of the intelligent calling apparatuses. In step S703, the software program run in the server similarly acquires the corresponding calling location according to the ID information stored in the disable signal. The information represents that one of the personnel members has arrived in the scene. In step S705, the software program in the server will combine some voice signals again in accordance with the aforementioned information. In step S707, the disable voice is formed. Similarly, by the specific channel, in step S709, the server performs the VOX technique to convert the disable voice to be the voice message so as to broadcast the voice message through the specific communication channel. The disable voice is transmitted to the intercoms of the personnel member representing that one of the personnel members has arrived in the calling location.

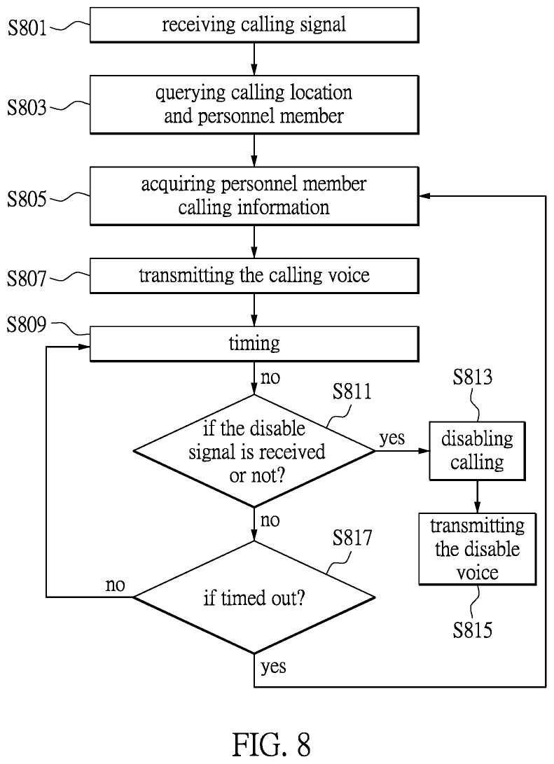

FIG. 8 is a flow char illustrating the method for using the intercom to perform the intelligent calling process in the embodiment.

At the beginning, in step S801, the server receives the calling signal generated by one of the intelligent calling apparatuses. Then, in step S803, the software program in the server can acquire the ID information of the intelligent calling apparatus and the ID information is corresponding to one of the calling locations. The personnel database is queried to acquire the corresponding calling location, the corresponding one or more personnel members and the information of the substitute in accordance with the ID information. In step S805, the calling information for each of the personnel members is acquired at the same time, and the calling information is the communication channel for the intercoms carried by the personnel member.

Thereafter, in step S807, according to the personnel look-up table representing the duty substitution relationships of the personnel members, by starting with the personnel member having a first priority and it is not limited to acquire one or more personnel members at one time, the calling voice is broadcast to the intercoms carried by the personnel member after being combined as the calling voice. The server can store the information of the update statuses, e.g., taking time off or not, idling, in service, service range or job duty, ability, characteristic of customers, service items, disabling or not, arriving time and etc., for all of the personnel members to make a comprehensive determination. Accordingly, one of the personnel members having the first priority is obtained by excluding all of the factors that cannot be attended.

After the server transmits the calling voice, as in step S809, the previous timer is reset and the timer starts timing the current calling process, and similar or different time limits can be set up according to any different situations.

In step S811, the software program executed by the server determines if the calling disable signal generated from the intelligent calling apparatus or the intercom is received or not. If yes, it represents that the personnel member is arrived at the calling location. In step S813, the current calling process is disabled. In step S815, the disable voice is transmitted to the intercoms of other personnel member and it represents that someone has moved to the calling location. Alternatively, if no, it represents that the disable signal is not received, the process moves to step S817. In step S817, if timing exceeding a time limit or not is determined? If timing is not run out (no), the timer will keep timing (step S809) and if the calling disable signal received or not is determined (step S811).

When timing exceeds the time limit (yes), it represents that there is no one of the personnel members arrived at the calling location. The process will start over and perform step S805 again to acquire the personnel member having next priority (e.g., the person may be one of the personnel members has been called before). The step of transmitting the calling voice, the step of timing and the steps of determining whether to execute the calling or not are performed again.

It should be noted that, in the specific embodiment, if the system includes many intelligent calling apparatuses and/or is capable of transmitting the signal in a wireless manner, a gateway can be installed in somewhere within the area and is configured to transfer the message generated by the intelligent calling apparatus.

It should be noted that the method for intelligent calling process is to implement in the area where the personnel members have to carry the intercoms. Therefore, when the personnel members receive the calling voice so that the personnel members acquire the calling location according to the content of the calling voice, the current calling process is completed. It is not requested to generate the calling disable signal through any devices. However, in a specific application, the intelligent calling apparatus (such as a sensor) can still include a timer. When time was running out without any personnel members arriving at the scene and the timer is turned off or the calling is not disabled, the calling signal has to be transmitted again.

It should be noted that the aforementioned server (or a software agent or a node agent) in the system, the intelligent calling apparatus 40, the first intercom 43, the second intercom 44 are arranged together to form an LAN, such as a low power Bluetooth communication (BLE) mesh network for IoT, which is able to broadcast packets to each other in BLE protocol. The server includes the personnel database to perform a table querying and the personnel database stores the calling location corresponding to the ID information of the intelligent calling apparatus, the calling information corresponding to the calling location for one or more personnel member. When each of the calling locations is corresponding to multiple personnel members, the personnel database stores a calling priority for the multiple personnel members corresponding to each of the calling locations. When calling the personnel member, the system will perform a sequential calling in accordance with the priority. Finally, it may require a supervisor to determine, so the server can transmit the calling voice to the supervisor. Moreover, in a specific circumstance, the multiple personnel member can be arranged in the groups, and each of the groups can set up different channels. By arranging into different groups, the calling voice can be transmitted to one group with some of the personnel members, and the personnel member determines to perform the duty in the calling voice or not.

In the embodiment, in the server, the calling voice formed by the software program can be combined by multiple segments of voice signals. The software program combines the requested voice signals according to the calling location and the calling information of the personnel member to form the calling voice to broadcast.

In summary, the method and system for intelligent calling process in the present disclosure can be performed by the intercom through the conventional voice communication, and a more convenient and intelligent process can be proposed in a place where a calling is required. The relevant POS systems or the servers can continue to generate big data, such as personnel member response time, equipment status, old customer analysis (service preferences, preferences for specific personnel member can affect the personnel member checklist), and security status for related areas. Moreover, in the invention of the applications with the IoT concepts, the intelligent calling apparatus can perform various functions. For example, different sensors in a specific place can connect to a security system, and when the system operates, huge amounts of data is generated to help improving service processes, enhancing service quality and providing customized services.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for using intercom to perform intelligent calling process, comprising steps of:
receiving a calling signal generated by an intelligent calling apparatus through a server, and the calling signal having identification (ID) information of the intelligent calling apparatus;
combining a plurality of voice signals related to the ID information in the server according to the ID information to form a calling voice; and
transmitting the calling voice to an intercom carried by at least one personnel member via a communication channel through the server.

2. The method for using intercom to perform intelligent calling process according to claim 1, wherein the ID information is corresponding to a calling location of the intelligent calling apparatus, and content of the calling voice includes the calling location.

3. The method for using intercom to perform intelligent calling process according to claim 2, wherein when the at least one personnel member moves at the calling location, a disable signal is generated through a trigger function of the intelligent calling apparatus and transmitted to the server.

4. The method for using intercom to perform intelligent calling process according to claim 2, wherein the server queries a personnel database according to the ID information to acquire calling information and a calling sequence of the at least one personnel member corresponding to the ID information.

5. The method for using intercom to perform intelligent calling process according to claim 4, wherein the calling information includes a name of the at least one personnel member or further including the communication channel for transmitting the calling voice.

6. The method for using intercom to perform intelligent calling process according to claim 5, wherein the at least one personnel member is arranged to be at least one group according to a plurality of the calling locations, and the at least one group includes a specific communication channel.

7. The method for using intercom to perform intelligent calling process according to claim 6, wherein when the at least one personnel member moves to the calling location, a disable signal is generated through a trigger function of the intelligent calling apparatus and transmitted to the server.

8. The method for using intercom to perform intelligent calling process according to claim 7, wherein after the server receives the disable signal, a disable voice is formed and transmitted to the intercom carried by the at least one personnel member to represent that the at least one personnel member is arrived at the calling location.

9. The method for using intercom to perform intelligent calling process according to claim 8, wherein a Voice-Operated Switch (VOX) technique is performed through the server to convert the calling voice and the disable voice to be a voice message broadcast via the specific communication channel.

10. An intelligent calling apparatus, comprising:
a control unit;
a trigger unit electrically connected to the control unit and generating a calling signal through the control unit after triggering;
a communication unit electrically connected to the control unit and configured to connect to a server so as to transmit the calling signal to the server; wherein the calling signal records ID information of the intelligent calling apparatus;
wherein when the intelligent calling apparatus generates and transmits the calling signal to the server, a plurality of voice signals related to the ID information are combined to form a calling voice according to the ID information; and the calling voice is transmitted to an intercom carried by at least one personnel member via a communication channel.

11. The intelligent calling apparatus according to claim 10, wherein the ID information is corresponding to a calling location of the call intelligent apparatus, and content of the calling voice includes the calling location.

12. The intelligent calling apparatus according to claim 11, wherein when the at least one personnel member moves to the calling location, a disable signal is generated through a trigger function of the intelligent calling apparatus and transmitted to the server.

13. A system for using intercom to perform intelligent calling process, comprising:
a plurality of intercoms carried by a plurality of personnel member;
a plurality of intelligent calling apparatuses disposed at a plurality of calling locations; and
a server having a process unit to perform a method for using the intercoms to implement the intelligent calling process, and the method comprising steps of:
receiving a calling signal generated by the intelligent calling apparatus through the server and the calling signal recording ID information of the intelligent calling apparatus;
combining a plurality of voice signals related to the ID information in the server according to the ID information to form a calling voice; and
transmitting the calling voice to at least one of the intercoms carried by at least one of the personnel member via a communication channel by the server.

14. The system for using intercom to perform intelligent calling process according to claim 13, wherein the ID information is corresponding to one of the calling locations for one of the call intelligent apparatuses, and content of the calling voice includes the calling location.

15. The system for using intercom to perform intelligent calling process according to claim 14, wherein when one of the personnel members moves to the calling location, a disable signal is generated through a trigger function of the intelligent calling apparatus and transmitted to the server.

16. The system for using intercom to perform intelligent calling process according to claim 14, wherein the server queries a personnel database according to the ID information to acquire calling information and a calling process of at least one of the personnel members corresponding to the ID information.

17. The system for using intercom to perform intelligent calling process according to claim 16, wherein the calling information includes a name of at least one of the personnel members or further having the communication channel for transmitting the calling voice.

18. The system for using intercom to perform intelligent calling process according to claim 17, wherein the personnel member are arranged to be a plurality of groups according to the different calling locations, and each of the groups includes a specific communication channel.

19. The system for using intercom to perform intelligent calling process according to claim 18, wherein after the server receives the disable signal, a disable voice is formed and transmitted to one of the intercoms carried by at least one of the personnel members to represent that at least one of the personnel members is arrived at the calling location.

20. The system for using intercom to perform intelligent calling process according to claim 19, wherein a Voice-Operated Switch (VOX) technique is performed through the server to convert the calling voice and the disable voice to be a voice message transmitted via the specific communication channel.
